(19) United States
(12) Patent Application Publication
(10) Pub. No.: US 2021/0192345 A1
(43) Pub. Date: Jun. 24, 2021

(54) METHOD FOR GENERATING LABELED DATA, IN PARTICULAR FOR TRAINING A NEURAL NETWORK, BY USING UNLABELED PARTITIONED SAMPLES

(71) Applicant: Robert Bosch GmbH, Stuttgat (DE)

(72) Inventors: Christian Haase-Schuetz, Fellbach (DE); Heinz Hertlein, Erlenbach (DE); Rainer Stal, Sindelfingen (DE)

(21) Appl. No.: 17/117,260

(22) Filed: Dec. 10, 2020

(30) Foreign Application Priority Data
Dec. 23, 2019 (DE) 102019220522.4
Jan. 16, 2020 (DE) 102020200499.4

(51) Int. Cl. G06N 3/08; G06N 3/04

(52) U.S. Cl. CPC G06N 3/08; G06N 3/04

(57) ABSTRACT

A method and a device for generating labeled data, for example training data, in particular for a neural network.

### CROSS REFERENCE

The present application claims the benefit under 35 U.S.C. § 119 of German Patent Application Nos. DE 102019220522.4 filed on Dec. 23, 2019, and DE 102020200499.4 filed on Jan. 16, 2020, which are both expressly incorporated herein by reference in their entireties.

### FIELD

The present invention relates to a method for generating labels, in particular for unlabeled data. The resulting labeled data may be used for example as training data, in particular for a neural network.

The present invention further relates to a device for implementing the first and/or the further method.

### BACKGROUND INFORMATION

Methods of machine learning, in particular of learning using neural networks, in particular deep neural networks (DNN), are superior to conventional non-trained methods for pattern recognition in the case of many problems. Almost all of these methods are based on supervised learning.

Supervised learning requires annotated or labeled data as training data. These annotations, also called labels below, are used as the target output for an optimization algorithm. For this purpose, at least one label is assigned to each data element.

The quality of the labels may affect the recognition performance of the trained models of the machine learning methods.

Conventionally, samples are manually labeled for the training of machine learning methods.

The present provides a method for generating labels that is improved compared to the related art.

### SUMMARY

One specific embodiment of the present invention provides a method for generating labels for a data set, the method comprising:

providing an unlabeled data set comprising a first subset of unlabeled data and at least one further subset of unlabeled data that is disjunctive with respect to the first subset;
generating a labeled first subset by generating labels for the first subset and providing the labeled first subset as the nth labeled first subset where n=1;
implementing an iterative process, an nth iteration of the iterative process comprising the following steps for every n=1, 2, 3, . . . N:
training a first model using the nth labeled first subset as the nth trained first model;
generating an nth labeled further subset by predicting labels for the further subset by using the nth trained first model;
training a further model using the nth labeled further subset as the nth trained further model;
generating an (n+1)th labeled first subset by predicting labels for the first subset by using the nth trained further model.

Starting from a labeled first subset, the method is based on training a first and a further model in an iterative method and thereby step-by-step to improve the labels, in particular a quality of the labels, predicted using the models. The capacity of trained models for generalization and/or the increasing accuracy of the trained models over the iterations are utilized for this purpose.

The unlabeled data of the unlabeled data set, or of the first and the further subset, are for example real data, in particular measured values from sensors, in particular multi-modal data. According to an exemplary, incomplete list, these sensors may be radar sensors, optical cameras, ultrasonic sensors, lidar sensors or infrared sensors, for example. Such sensors are generally used in autonomous and partially autonomous functions in motor vehicles or generally in robots.

Labels are generated for the at first still unlabeled data of the first subset. One advantage of the disclosed method is that a faulty generation of the label suffices in this step. Hence it is possible to implement the generation of the labels in a comparatively simple fashion and thus relatively quickly and cost-effectively.

The labels for the first subset are generated for example using an automatic method. It may prove advantageous to use a non-trained method, in particular a conventional pattern recognition algorithm, for which no training data are required. In particular, it is also possible to use a method trained on another data set without adaptation to the current data set. Specific embodiments are also possible, in which the labels for the first subset are generated manually.

In order to improve the generalization of the trained model during implementation of the iterative process and to avoid systematic errors being learned in the initial labels, it is in particular also possible initially to refrain from using a portion of the information of the data of the unlabeled data set in particular at the beginning of the iterative process. In particular, it may be expedient initially not to use information such as is essential for generating the initial labels using the non-trained pattern recognition algorithm. In the further course of the iterative process, the information that is not used at first may eventually be used. An example of this is the use of color information in images for generating the initial labels, where the color information is at first not provided in the iterative process, that is, the original color images are converted into gray-tone images. The color information may be added in the further course of the iterative process, it then being possible to adapt the architecture of the trainable model accordingly in order to process the additional information, for example the color images instead of the gray-tone images.

It may prove to be advantageous if the first subset and the further subset are approximately, in particular precisely, of the same size, or comprise approximately, in particular precisely, an equal number of unlabeled data.

An advantage of the example method of the present invention is that in the course of the iterative process the training of the first and of the further model is performed in every step using data that are disjunctive with respect to the data for which the respective model subsequently performs a prediction. Thus, it is possible to prevent errors that exist in the labels at the beginning of the iterations from propagating during the training of a respective model and further until the end of the iterative process. Thus, the training of a respective model is started in each iteration anew “from zero” or “from scratch.” Thus, this is not merely an adaptation of the model of the previous iteration. This improves the generalization capacity of the respective model and of the entire method and thus expands the applicability of the method. Advantageously, the alternating use of two or more disjunctive subsets improves the generalization and suppresses overadaptation or overfitting.

The labels generated by the method may be provided together with the data set as labeled, or annotated, training data for training a model, in particular a neural network.

According to a further specific embodiment of the present invention, following the nth iteration of the iterative process, a final model is trained using the nth labeled first subset and/or the nth labeled further subset. By combining the first and the further subsets it is possible to increase, in particular to double, the quantity of the training data for training the final model. This advantageously makes it possible to increase a prediction quality of the resulting final model. The resulting model may then be used for predicting labels for the entire data set. Advantageously, prediction using the final model makes it possible to generate an optimized version of labels for the data set.

Another specific embodiment of the present invention provides for a labeled data set and/or a final labeled data set to be generated by predicting labels for the data set using the final model. Advantageously, prediction using the final model makes it possible to generate an optimized version of labels for the data set and thus an optimized labeled data set.

A further specific embodiment of the present invention provides for the labeled first subset to be generated by predicting labels using an initial model. It may prove advantageous that the initial model comprises a non-trained model, in particular a conventional pattern recognition algorithm, for which no training data are required.

Another specific embodiment of the present invention provides for the initial model to be trained in a preceding step using a labeled initial subset, and for the initial subset to be disjunctive with respect to the first and the further subset. The initial subset is labeled manually for example.

Another specific embodiment of the present invention provides for the initial subset to be smaller, that is, to comprise a smaller number of data, than the first subset and/or to be smaller, that is, to comprise a smaller number of data, than the further subset. This may prove advantageous for example in that the initial subset may be labeled manually in a comparatively cost-effective manner. The generation of labels for the first and the further subsets then occurs in the iterative process as described above.

Another specific embodiment of the present invention provides for steps of the iterative process to be performed repeatedly for as long as a quality criterion and/or termination criterion is not yet fulfilled. A quality criterion comprises for example the quality of the generated labels or a prediction quality of the model. A termination criterion comprises for example the exceeding or undershooting of a threshold value, in particular a number of iterations to be performed or a value for the change of the labels from one iteration to the next or a quality measure for the labels. The assessment of the quality of the labels and/or of the prediction quality may be performed for example on the basis of a labeled reference sample of good quality. Alternatively, the quality may be assessed on the basis of confidences of the model, which are output in addition to the predicted labels. For this purpose, the confidences may be standardized, it being possible to perform the standardization for example by using a portion of the labeled data set obtained for this step by prediction. In this case, this portion is not used for training.

Another specific embodiment of the present invention provides for the first model and/or the further model and/or the initial model and/or the final model to comprise a neural network, in particular a deep neural network.

Another specific embodiment of the present invention provides for the method to further comprise: increasing a complexity of the first model and/or of the further model. There may be a provision to increase the complexity of the first and/or of the further model in every iteration n, n=1, 2, 3, . . . N. There may also be a provision for the complexity of the final model to be increased in comparison to the complexity of the first and/or of the further model of the last iteration of the iterative process.

Advantageously it may be provided that at the beginning of the iterative process, that is, in the first iteration and in a certain number of further iterations relatively at the beginning of the iterative process, a first and/or further model is trained, which is simpler with respect to the type of mathematical model and/or with respect to the complexity of the model and/or which contains a smaller number of parameters to be estimated within the scope of the training. It may then be further provided that in the course of the iterative process, that is, after a certain number of further iterations of the iterative process, a first and/or further model is trained, which is more complex with respect to the type of mathematical model and/or more complex with respect to the complexity of the model and/or which contains a greater number of parameters to be estimated within the scope of the training.

Another specific embodiment of the present invention relates to a method for generating labels for a data set, the method comprising:

providing an unlabeled data set comprising a first subset of unlabeled data and at least one further subset of unlabeled data, which is disjunctive with respect to the first subset, the subset comprising at least one first sub-subset and a second sub-subset, in particular k sub-subsets where k=1, 2, 3 . . . K, k indicating the index of the respective sub-subset;
generating an initial labeled subset by generating labels for the first subset;
training a model using the initial labeled subset as the nth trained model where n=1;
implementing an iterative process, an nth iteration of the iterative process comprising the following steps for every n=1, 2, 3, . . . N:
generating an nth labeled sub-subset by predicting labels for the kth sub-subset by using the nth trained model;
training the model as the (n+1)th trained model using the nth labeled sub-subset. In another specific embodiment, the (n+1)th trained model is trained using the kth labeled sub-subset and the initial labeled subset.

In one specific embodiment of the present invention, the number N of the iterations of the iterative process is equal to the number K of the sub-subsets. Thus, in this specific embodiment, the iterative process is run through until labels have been predicted precisely one time for every sub-subset and until using each of the thus labeled sub-subsets a training was performed precisely once.

In a further specific embodiment of the present invention, the number N of the iterations of the iterative process is smaller than the number K of the sub-subsets. In this case, not all sub-subsets are used. This may be expedient if the iterative process is terminated due to a termination criterion before all sub-subsets are applied.

In a further specific embodiment of the present invention, the number N of the iterations of the iterative process is greater than the number K of the sub-subsets. In this case, some or all sub-subsets are used more than once. In this case, in the nth iteration of the iterative process, it is possible for example to use the (((n−1) modulo K)+1)th sub-subset.

Starting from the initial labeled subset, the method is based on training a model in an iterative method and step-by-step to improve the labels, in particular a quality of the labels, predicted using the model. The capacity of trained model for generalization and/or the increasing accuracy of the trained model over the iterations of the iterative process are utilized for this purpose.

The unlabeled data of the unlabeled data set, or of the first and the further subset, are for example real data, in particular measured values from sensors, in particular multi-modal data. According to an exemplary, incomplete list, these sensors may be radar sensors, optical cameras, ultrasonic sensors, lidar sensors or infrared sensors, for example. Such sensors are generally used in autonomous and partially autonomous functions in motor vehicles or generally in robots.

Initial labels are generated for the at first still unlabeled data of the first subset. The generation of the initial labels for the first subset occurs manually for example. Specific embodiments are also possible, in which the generation of the initial labels occurs by using semi-automatic or automatic methods, in particular by using a conventional pattern recognition algorithm.

It may prove to be advantageous if the first subset is smaller, or comprises a smaller number of data, than the further subset. It may further prove to be advantageous if the sub-subsets of the further subset are approximately, in particular precisely, of the same size, or comprise approximately, in particular precisely, an equal number of unlabeled data.

One advantage of the example method in accordance with the present invention is that in the course of the iterative process the training of the model is performed in every step using data that are at least partially disjunctive with respect to the data for which the model subsequently performs a prediction. Thus it is possible to prevent errors that exist in the labels at the beginning of the iterations from being retained during the training of the model and further until the end of the iterative process. In every iteration of the iterative process, an unseen sub-subset is used. Thus, the model trained in the respective iteration is applied to a sub-subset that was not used for training the model in the preceding iteration.

In order to produce an improved model in every iteration, a new training is performed, the labeled sub-subset of the respective iteration being used for this purpose. In another specific embodiment, the initial labeled subset may be used in addition for the training.

The labels generated by the method may be provided together with the data set as labeled, or annotated, training data for training a model, in particular a neural network.

Another specific embodiment of the present invention provides for generating a further labeled subset subsequent to the nth iteration of the iterative process by predicting labels for the further subset using the trained model. This step may advantageously be performed by applying the nth trained model to the unlabeled data set.

A further specific embodiment of the present invention provides for generating a labeled data set comprising the initial labeled subset and the further labeled subset. This step is advantageously performed subsequent to the nth iteration of the iterative process, in particular following the conclusion of the iterative process.

Another specific embodiment of the present invention provides for training a final model using the labeled data set and/or for generating a labeled data set by predicting labels for the data set using the final model. Advantageously, prediction using the final model makes it possible to generate an optimized version of labels for the data set and thus an optimized labeled data set.

Another specific embodiment of the present invention provides for steps of the iterative process to be performed repeatedly for as long as a quality criterion and/or termination criterion is not yet fulfilled. A quality criterion comprises for example the quality of the generated labels or a prediction quality of the model. A termination criterion comprises for example the exceeding or undershooting of a threshold value, in particular a number of iterations to be performed or a value for the change of the labels from one iteration to the next or a quality measure for the labels. The assessment of the quality of the labels and/or of the prediction quality may be performed for example on the basis of a labeled reference sample of good quality. Alternatively, the quality may be assessed on the basis of confidences of the model, which are output in addition to the predicted labels. For this purpose, the confidences may be standardized, it being possible to perform the standardization for example by using a portion of the labeled data set obtained for this step by prediction. In this case, this portion is not used for training. It is possible to specify the number of iterations to be performed for example via the number of the sub-subsets of the further subset. One specific embodiment provides that after running through the number of iterations in accordance with the number of sub-subsets the iterative process is run through again using the already utilized sub-subsets so that the number of iterations is all in all greater than the number of the sub-subsets.

Another specific embodiment of the present invention provides for the model and/or the final model to comprise a neural network, in particular a deep neural network.

Another specific embodiment of the present invention provides for the method to comprise further: increasing a complexity of the model. There may be a provision to increase the complexity of the model in every iteration n, n=1, 2, 3, . . . N. Advantageously it may be provided that at the beginning of the iterative process, that is, in the first iteration and in a certain number of further iterations relatively at the beginning of the iterative process, a model is trained, which is simpler with respect to the type of mathematical model and/or with respect to the complexity of the model and/or which contains a smaller number of parameters to be estimated within the scope of the training. It may then be further provided that in the course of the iterative process, that is, after a certain number of further iterations of the iterative process, a model is trained, which is more complex with respect to the type of mathematical model and/or more complex with respect to the complexity of the model and/or which contains a greater number of parameters to be estimated within the scope of the training.

A further specific embodiment of the present invention relates to a device, the device being designed to implement one or multiple methods in accordance with the specific embodiments described above.

A further specific embodiment of the present invention provides for the device to comprise a computing device and a storage device, in particular for storing at least one model, in particular a neural network.

Another specific embodiment of the present invention relates to a computer program, the computer program comprising computer-readable instructions, one or more methods according to the specific embodiments described above being carried out when the instructions are executed by a computer.

A further specific embodiment of the present invention relates to a computer program product, the computer program product comprising a computer-readable storage medium, on which a computer program according to the specific embodiments is stored.

Another specific embodiment of the present invention relates to the use of at least one method according to the above-described specific embodiments and/or of a device according to the specific embodiments and/or of a computer program according to the specific embodiments and/or of a computer program product according to the specific embodiments for generating training data for training a model, in particular a neural network.

Another specific embodiment of the present invention relates to a use of a labeled data set, the labeled data set having been generated using a method according to the specific embodiments and/or using a device according to the specific embodiments and/or using a computer program according to the specific embodiments and/or using a computer program product according to the specific embodiments, for training a model, in particular a neural network.

In accordance with an example embodiment of the present invention, a use is possible for example in classification methods, recognition methods, in particular biometric recognition methods, in particular voice recognition, facial recognition, iris recognition, or in particular object detection, object tracking etc.

In accordance with an example embodiment of the present invention, a use in “lifelong learning” approaches is likewise possible. Such an approach is characterized by further training during the use of a method.

The example method is particularly suitable for labeling data recorded by sensors. The sensors may be cameras, lidar sensors, radar sensors, ultrasonic sensors, for example. The data labeled using the method are preferably used for training a pattern recognition algorithm, in particular an object recognition algorithm. By way of these pattern recognition algorithms, it is possible to control various technical systems and to achieve for example medical advances in diagnostics. Object recognition algorithms trained using the labeled data are especially suitable for use in control systems, in particular driving functions, in at least partially automated robots. These may thus be used for example for industrial robots in order specifically to process or transport objects or to activate safety functions, for example a shut down, based on a specific object class. For automated robots, in particular automated vehicles, such object recognition algorithms may be used advantageously for improving or enabling driving functions. In particular, based on a recognition of an object by the object recognition algorithm, it is possible to perform a lateral and/or longitudinal guidance of a robot, in particular of an automated vehicle. Various driving functions such as emergency braking functions or lane-keeping functions may be improved by using these object recognition algorithms.

Additional features, application options and advantages of the present invention result from the following description of exemplary embodiments of the present invention, which are shown in the figures. For this purpose, all of the described or illustrated features form the subject of the present invention, either alone or in any combination, irrespective of their combination or formulation or representation in the description or in the figures. Steps of the method are shown schematically as rectangles, data are shown schematically as cylinders, transitions between the individual method steps and data are shown as arrows, and data flows are shown as dashed arrows.

### BRIEF DESCRIPTION OF THE DRAWINGS

FIG. 1 shows a schematic representation of steps of a first method in a flow chart, in accordance with an example embodiment of the present invention.

FIG. 2 shows a schematic representation of a first method in a block diagram according to a first preferred specific embodiment of the present invention.

FIG. 3 shows a schematic representation of the method according to another preferred specific embodiment in accordance with the present invention in a block diagram.

FIG. 4 shows a schematic representation of steps of a further method in a flow chart, in accordance with an example embodiment of the present invention.

FIG. 5 shows a schematic representation of a further method according to a specific embodiment of the present invention in a block diagram.

FIG. 6 shows a schematic representation of a further method according to a further specific embodiment of the present invention in a block diagram.

FIG. 7 shows a device according to a preferred specific embodiment of the present invention in a simplified block diagram.

### DETAILED DESCRIPTION OF EXAMPLE EMBODIMENTS

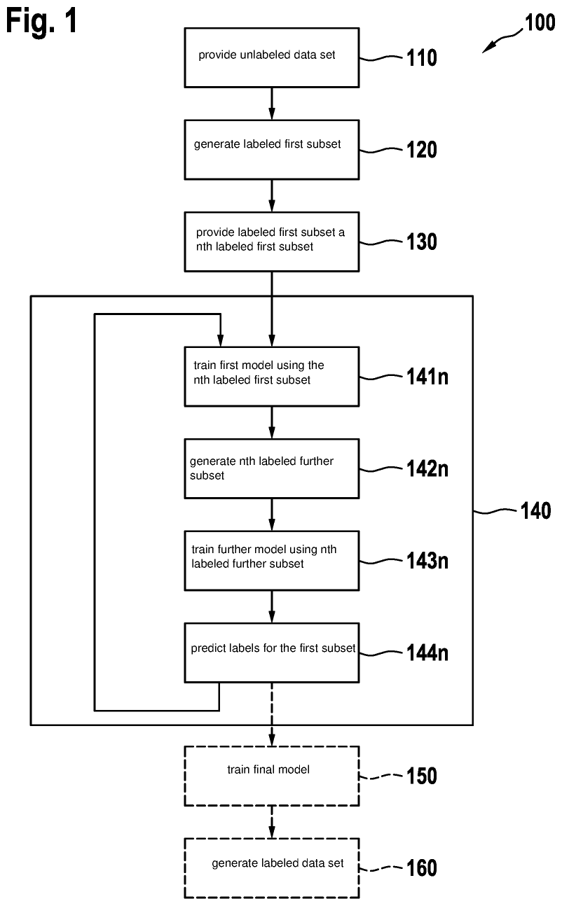

FIG. 1 shows a schematic representation of steps of a method 100 for generating labels, in particular final labels L_f, for a data set S. The method 100 comprises the following steps:

a step 110 for providing the unlabeled data set S comprising a first subset SA of unlabeled data and at least one further subset SB of unlabeled data that is disjunctive with respect to the first subset;
a step 120 for generating a labeled first subset SA_L_1 by generating labels L_A_1 for the first subset SA,
and a step 130 for providing the labeled first subset SA_L_1 as the nth labeled first subset SA_L_n where n=1;
a step 140 for implementing an iterative process, an nth iteration of the iterative process comprising the following steps for every n=1, 2, 3, . . . N:
a step 141n for training a first model MA using the nth labeled first subset SA_L_n as the nth trained first model MA_n;
a step 142n for generating an nth labeled further subset SB_L_n by predicting labels L_B_n for the further subset SB by using the trained model MA_n;
a step 143n for training a further model MB using the nth labeled further subset SB_L_n as the nth trained further model MB_n;
a step 144n for generating an (n+1)th labeled first subset SA_L_n+1 by predicting labels L_A_n+1 for the first subset SA by using the nth trained further model MB_n.

According to the illustrated specific embodiment of the present invention, the method further comprises a step for training 150 a final model M_f using the nth labeled first subset SA_L_n and/or the nth labeled further subset SB_L_n. Step 150 is performed following the nth iteration of the iterative process.

According to the illustrated specific embodiment of the present invention, the method further comprises a step 160 for generating a labeled data set S_L_f by predicting labels L_f for the data set S using the final model M_f.

An advantage of method 100 is that in the course of the iterative process 140 the training of the first and of the further untrained model MA, MB is performed in every iteration using data that are disjunctive with respect to the data for which the respective trained model MA_n, MB_n subsequently performs a prediction. Thus it is possible to prevent errors that exist in the labels L_A_1 und L_B_1 bis L_A_N und L_B_N, in particular at the beginning of the iterations from propagating during the training of a respective model MA, MB and furthermore until the end of the iterative process. Thus, the training of the respective model MA, MB is started in each iteration anew “from zero” or “from scratch.” Thus, there is not merely an adaptation of the model MA_n−1, MB_n−1 of the previous iteration. This improves the generalization capacity of the respective model MA, MB and of the entire method 100 and thus expands the applicability of method 100. Advantageously, the alternating use of two or more disjunctive subsets SA, SB improves the generalization and suppresses overfitting.

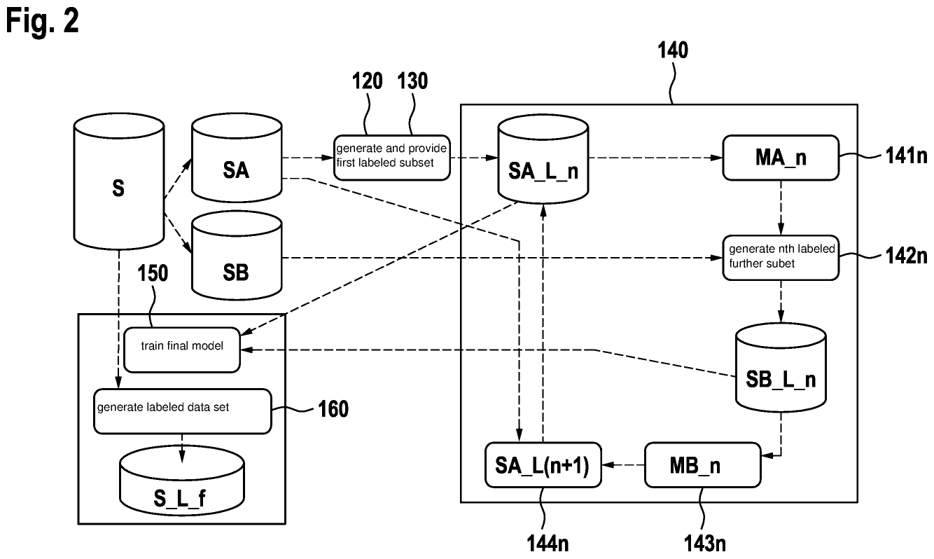

A first specific embodiment of method 100 is explained below with reference to FIG. 2.

The unlabeled data set S comprises a first subset SA of unlabeled data and a further subset SB of unlabeled data that is disjunctive with respect to the first subset.

According to the illustrated specific embodiment, the first subset SA and the further subset SB are approximately, in particular precisely, of the same size, or comprise approximately, in particular precisely, an equal number of unlabeled data.

In step 120, the labeled first subset SA_L_1 is generated by generating labels L_A_1 for the first subset SA and is provided in step 130 as the nth labeled first subset SA_L_n where n=1.

The labels L_A_1 for the first subset SA are generated for example using an automatic method. According to the specific embodiment, the automatic method may comprise non-trained method, in particular a conventional pattern recognition algorithm, for which no training data are required.

If the unlabeled data S are time-dependent data, the automatic method may also perform an offline processing for example. For this purpose, it is also possible to combine single frame methods, which operate on individual frames, in particular deep learning based object recognition, with methods that utilize temporal consistency, for example tracking.

Alternatively, the labels L_A_1 for the first subset SA may also be generated manually.

For better comprehension, the steps of the iterative process 140 are framed by boxes indicated by reference numeral 140.

Every nth iteration of the iterative process comprises the following steps for every n=1, 2, 3, . . . N:

in step 141n, the first model MA is trained using the nth labeled first subset SA_L_n as the nth trained first model MA_n;
in step 142n, the nth labeled further subset SB_L_n is generated by predicting labels L for the further subset SB by using the trained model MA_n;
in step 141n, the model MB is trained, using the nth labeled further subset SB_L_n generated in step 142n, as the nth trained further model MB_n;
in step 144n for generating an (n+1)th labeled first subset SA_L_n+1 by predicting labels L_A_n+1 for the first subset SA by using the nth trained further model MB_n.

In the course of iterative process 140, the training of the first and of the further model MA, MB is performed in every step using data that are disjunctive with respect to the data for which the respective model MA_n, MB_n subsequently performs a prediction.

An increase in the label quality or a reduction in the error rate is achieved by running through the iterations of the iterative process 140 multiple times.

The iterative process 140 is performed for example for as long as a quality criterion and/or termination criterion is not yet fulfilled. A quality criterion comprises for example the quality of the generated labels L_A_n and L_B_n or a prediction quality of the first and/or of the further model MA, MB. A termination criterion comprises for example the exceeding or undershooting of a threshold value, in particular a number of iterations to be performed or a value, calculated for example on the basis of a distance measure, for the change of the labels L_A_n and/or L_B_n from one iteration to the next or a quality measure for the labels L_A_n and/or L_B_n. The assessment of the quality of the labels L_A_n and/or L_B_n and/or of the prediction quality may be performed for example on the basis of a labeled reference sample of good quality. Alternatively, the quality may be assessed on the basis of confidences of the first and/or of the further model MA, MB, which are output in addition to the predicted labels L_A_n and/or L_B_n. For this purpose, the confidences may be standardized, it being possible to perform the standardization for example by the ability to use a portion of the labeled data set obtained for this step by prediction. In this case, this portion is not used for training.

Subsequent to the iterative process, a final training process may be performed. The final training process comprises for example the steps 150, 160 from FIG. 1. According to the illustrated specific embodiment, the (N+1)th labeled first subset SA_L_N+1 and the nth labeled further subset SB_L_N from the last nth iteration are used for training 150 the final model M_f. The final model M_f is trained for example on the labels of the last nth iteration L_A_N and L_B_N.

Subsequently, in step 160, the labeled data set S_L is generated by predicting labels L_f for the data set S using the final model M_f.

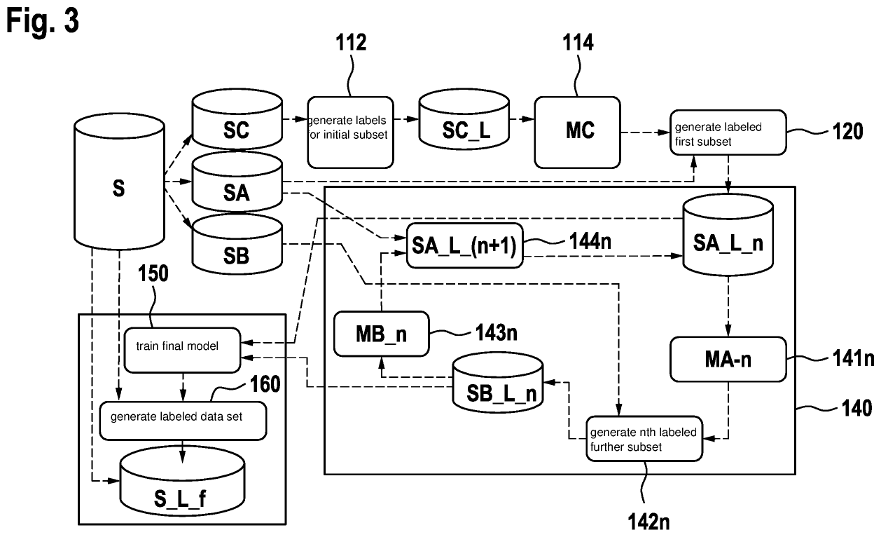

FIG. 3 shows another specific embodiment of method 100. The unlabeled data set S comprises in addition to the first and the further subset SA, SB an initial subset SC. The initial subset SC may likewise be disjunctive with respect to the first and to the further subset SA, SB, although it is also possible that SC represents a subset of SA and/or SB.

In a step 112, labels L_C are generated for the initial subset SC, in particular using a manual method.

In a step 114, an initial model MC is trained using the labeled initial subset SC_L.

The specific embodiment further provides for the labeled first subset SA_L_n to be generated 120 by predicting labels using the trained initial model MC.

The initial subset SC is advantageously smaller or comprises a smaller number of data than the first subset SA and/or than the further subset SB. This may prove advantageous for example in that the initial subset may be labeled manually in a comparatively cost-effective manner.

The generation of labels for the first and the further subset SA, SB then occurs using the iterative process 140 described with reference to FIG. 1 and FIG. 2.

In the event that SC is a subset of SA and/or SB, new labels are predicted in the iterations of the iterative process for those data set elements (samples) that occur both in SC as well as in SA and/or SB. In one specific embodiment, these predicted labels can replace the initial labels L_C so that the initial labels are used only at the beginning. In another specific embodiment, it is possible to use some of the initial labels in an iteration step of the iterative process, while some of the initial labels are replaced by predicted labels. Which of these labels are used unchanged and which are replaced may change in the course of the iterative process, in particular the ratio of labels that are used unchanged and labels that are replaced may change. An advantage may result from using a greater portion of unchanged initial labels at the beginning of the iterative process and a greater portion of predicted labels in the further course of the iterative process, if the initial labels are faulty and the quality of the predicted labels exceeds the quality of the initial labels in the course of the iterative process. If by contrast the quality of the initial labels is high, then it is generally possible to use the initial labels in all iteration steps of the iterative process so that it is not necessary to perform a prediction in the iterations for those data set elements that occur both in SC as well as in SA and/or SB. In this case, the labeled sample SC_L may be designated a reference sample.

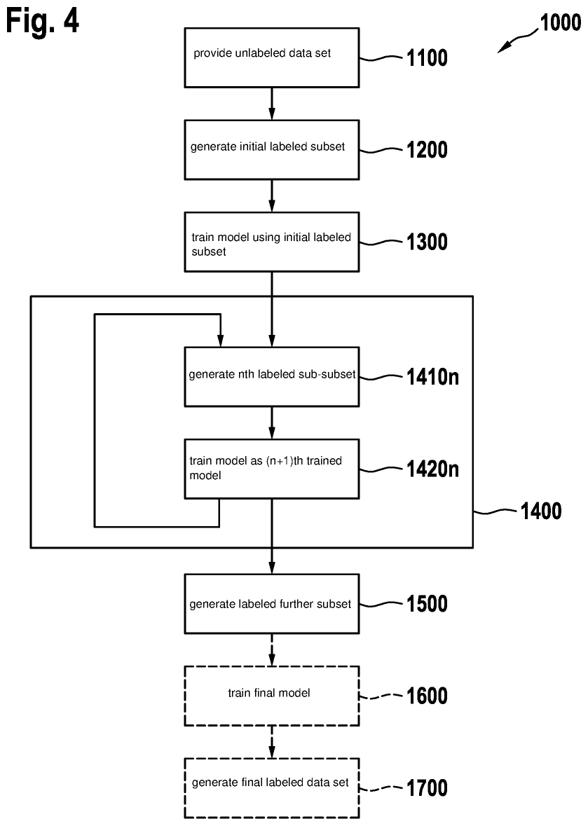

FIG. 4 shows a schematic representation of steps of a further method 1000 for generating labels L_f for a data set S. The method 1000 comprises the following steps:

a step 1100 for providing a unlabeled data set S comprising a first subset SA of unlabeled data and at least one further subset SB of unlabeled data that is disjunctive with respect to the first subset; Subset SB comprises at least a first sub-subset SB_1 and a second sub-subset SB_2, in particular K sub-subsets SB_k where k=1, 2, 3 . . . K;
a step 1200 for generating an initial labeled subset SA_L by generating labels L_A for the first subset SA,
a step 1300 for training a model M using the initial labeled subset SA_L as the nth trained model M_n where n=1;
a step 1400 for implementing an iterative process, an nth iteration of the iterative process comprising the following steps for every n=1, 2, 3, . . . N:
a step 1410n for generating an nth labeled sub-subset SB_n_L by predicting labels L_n for the nth sub-subset SB_n by using the nth trained model M_n;
a step 1420n for training the model M as the (n+1)th trained model M_n+1 using the nth labeled sub-subset SB_n_L and the initial labeled subset SA_L. In a further, alternative specific embodiment, the step 1420n comprises training the model M as the (n+1)th trained model M_n+1 using only the nth labeled sub-subset SB_n_L, but without the initial labeled subset SA_L.

According to the illustrated specific embodiment, the method 1000 further comprises a step 1500 for generating a labeled further subset SB_L by predicting labels L for the further subset SB. This step advantageously occurs by applying the nth trained model M_n to the unlabeled further subset SB, advantageously comprising the sub-subsets SB_1 SB_2, . . . SB_n. Step 1500 is performed following the nth iteration of the iterative process 1400. The last Nth iteration of the iterative process generates the model M_N+1 in step 1420N.

According to the illustrated specific embodiment, step 1500 further comprises generating a labeled data set S_L comprising the initial labeled subset SA_L and the labeled further subset SB_L.

According to the illustrated specific embodiment, method 1000 further comprises an, in particular optional, step 1600 for training a final model M_f using the labeled data set S_L and an, in particular optional, step 1700 for generating a final labeled data set S_L_f using the final model M_f by predicting labels L for data set S. Advantageously, prediction using the final model M_f makes it possible to generate an optimized version of labels for the data set S and thus an optimized labeled data set S_L_f.

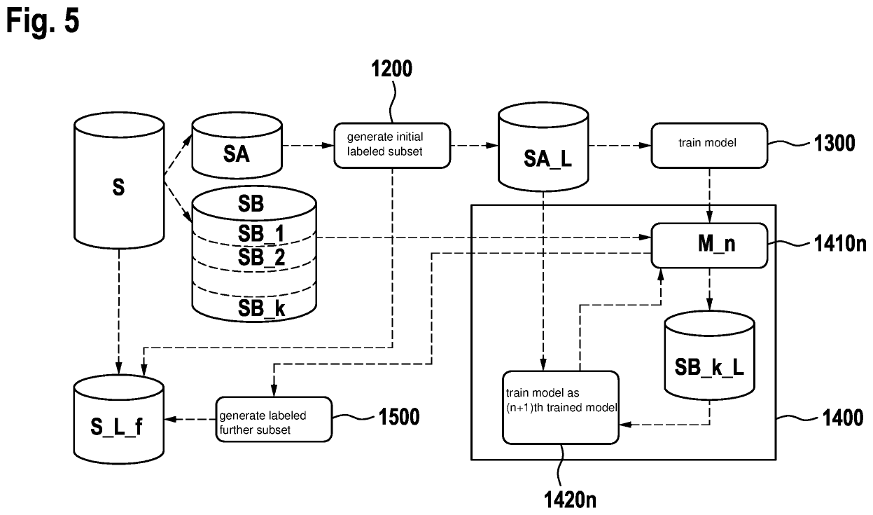

A first specific embodiment of method 1000 is explained below with reference to FIG. 5.

The unlabeled data set S comprises the first subset SA of unlabeled data and the, in particular further, subset SB of unlabeled data. Subset SB comprises a number n of sub-subsets SB_n where n=1, 2, 3, . . . N, in particular the first sub-subset SB_1, the second sub-subset SB_2, etc.

It may prove to be advantageous if the first subset SA is smaller, that is, comprises a smaller number of data, than the further subset SB. It may further prove to be advantageous if the sub-subsets SB_1, SB_2, . . . SB_n of the further subset SB are approximately, in particular precisely, of the same size, or comprise approximately, in particular precisely, an equal number of unlabeled data.

In step 1200, the initial labeled subset SA_L is generated by generating labels L for the first subset SA. The generation of the initial labels for the first subset SA occurs manually for example. Specific embodiments are also possible, in which the generation of the initial labels L occurs semi-automatically or automatically, in particular by using a conventional non-trained pattern recognition algorithm, or by using a trained model.

In step 1300, model M is trained using the initial labeled subset SA_L as the nth trained model M_n where n=1.

For better comprehension, the steps of the iterative process 1400 are framed by boxes indicated by reference numeral 1400.

Every nth iteration of iterative process 1400 comprises the following steps for every n=1, 2, 3, . . . N:

the step 1410n for generating an nth labeled sub-subset SB_n_L by predicting labels L for the nth sub-subset SB_n by using the nth trained model M_n;
the step 1420n for training the model M as the (n+1)th trained model M_n+1 using the nth labeled sub-subset SB_n_L and the initial labeled subset SA_L.

The iterative process 1400 is performed for example for as long as a quality criterion and/or termination criterion is not yet fulfilled. A quality criterion comprises for example the quality of the generated labels L or a prediction quality of model M_n. A termination criterion comprises for example the exceeding or undershooting of a threshold value, in particular a number of iterations to be performed or a value for the change of the labels L from one iteration to the next or a quality measure for the labels L. The assessment of the quality of the labels L and/or of the prediction quality may be performed for example on the basis of a labeled reference sample of good quality. Alternatively, the quality may be assessed on the basis of confidences of the model M_n, which are output in addition to the predicted labels L. For this purpose, the confidences may be standardized, it being possible to perform the standardization for example by using a portion of the labeled data set obtained for this step by prediction. In this case, this portion is not used for training. It is possible to specify the number n of the iterations to be performed for example via the number n of the sub-subsets SB_n of the further subset SB.

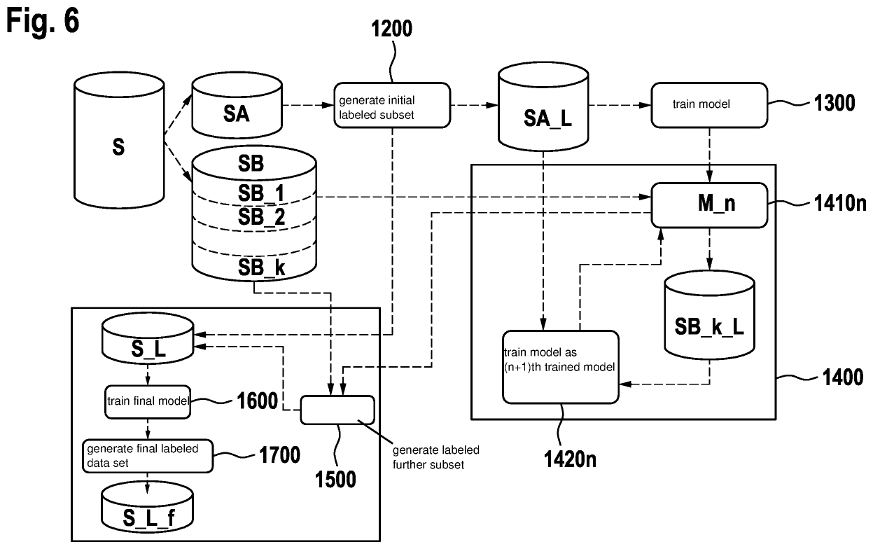

FIG. 6 shows the method 1000 from FIG. 5, the specific embodiment of method 1000 shown in FIG. 6 being expanded by a final training process. The final training may be performed following the iterative process. The final training process comprises for example the steps 1500, 1600 and 1700 from FIG. 4. In step 1500, first the labeled further subset SB_L is generated by predicting labels L for the further subset SB. According to the illustrated specific embodiment, step 1500 further comprises generating a labeled data set S_L comprising the initial labeled subset SA_L and the labeled further subset SB_L.

In step 1600, the final model M_f is trained using the labeled data set S_L. In step 1700, the final labeled data set S_L_f is generated with the assistance of the trained final model M_f by predicting labels L for data set S. Advantageously, prediction using the final model M_f makes it possible to generate an optimized version of labels for the data set S and thus an optimized labeled data set S_L_f.

Optionally, a weighted training of model M may be provided in the specific embodiments of the method shown in FIGS. 4 through 6.

For example, there may be a provision to weight data of the nth labeled sub-subset SB_n_L and data of the initial labeled subset SA_L for training model M as the (n+1)th trained model M_n+1.

It may prove to be advantageous for example to weight data of the initial labeled subset SA_L higher than data of the nth labeled sub-subset SB_n_L. The weighting may also be changed in the course of the iterations of the iterative process 1400. In this connection, it may prove advantageous if data of the initial labeled subset SA_L are weighted higher at the beginning of the iterative process 1400 than in higher iterations.

There may also be a provision that model M is suitable for generating a confidence and is used for this purpose. The confidence may then continue to be used in order to weight data of the nth labeled sub-subset SB_n_L. For this purpose, the confidences may be standardized, it being possible to perform the standardization for example by using a portion of the labeled data set obtained by prediction. In this case, this portion is not used for training model M.

Advantageously, labels incorrectly predicted due to the weighting have a less pronounced effect in particular at the beginning of the iterative process 1400 so that a higher quality of the labeled sub-subset SB_n_L can be achieved using fewer iterations.

Optionally, a step for increasing the model complexity may be provided in the specific embodiments of method 100, 1000 shown in FIGS. 1 through 6.

Advantageously, it may be provided to increase the complexity of model M, MA, MB in the course of the iterations. Advantageously, there may be a provision to increase the complexity of model M, MA, MB in every iteration n, n=1, 2, 3, . . . N.

One specific embodiment may provide that at the beginning of the iterative process 140, 1400, that is, in the first iteration and in a certain number of further iterations relatively at the beginning of the iterative process 140, 1400, a model M, MA, MB is trained, which is simpler with respect to the type of mathematical model and/or with respect to the complexity of the model and/or which contains a smaller number of parameters to be estimated within the scope of the training.

A specific example embodiment is explained by way of example for the application of method 100, 1000 to a classification problem by using the expectation maximization algorithm or EM algorithm. The EM algorithm is used to estimate the class-specific distributions of the data of data set S or the class-specific distributions of characteristics calculated from the data of data set S. The classification is based on maximizing the class-specific probability, for example by using the Bayes theorem. The EM algorithm may be used for example for estimating the parameters of Gaussian mixture distributions. When using Gaussian mixture distributions, it is possible to increase the model complexity by increasing the number of Gauss distributions that are estimated per mixture (and thus per class). Thus, in this example, a comparatively small number of Gauss distributions would be used at the beginning of the iterative process, and this number would be continuously increased in the course of the iterations.

Another specific example embodiment is explained by way of example for the application of method 100, 1000 by using a neural network, in particular a deep neural network (DNN) as model M, MA, MB. In this case, the model complexity may be changed via the architecture of the neural network. The greater the number of layers and the greater the number of neurons per layer, generally the higher will be the number of parameters estimated in training and thus the complexity of the neural network. In the concrete case, the type of linkages between the layers may also play a role.

In general, an increase of the complexity of model M, MA, MB, inter alia by increasing the number of the parameters of model M, MA, MB to be estimated in training, may improve the ability of the model to adapt to training data, i.e., to learn the distribution of the data. This advantageously results in a better recognition performance. In some cases, a high complexity of the model M, MA, MB may also result in a poorer generalization capacity and in a so-called overfitting on the training data. While the recognition performance continues to rise with increasing model complexity on the training data, it falls on unseen test data. Overfitting may be all the more of a problem, the fewer data are available for the training.

In the method 100, 1000 disclosed here, this effect may be significant since the labels L used for the training, for example L_A_n, L_B_n, L_f are more faulty at the beginning of the iterative process than after repeated execution of iterations of the iterative process. As a result, the achieved recognition performance may be worse at the beginning of the process than the recognition performance at the end of the process. It may therefore be advantageous to achieve a good generalization capacity at the beginning of the process and to avoid overfitting. It may possibly also prove advantageous to accept a certain error rate due to a comparatively lower complexity of model M, MA, MB. In the course of the iterative process, the quality of the labels L improves continuously so that more training data of better quality are available. After a certain quality of the labels L has been achieved, it may then be advantageous to increase the complexity of model M, MA, MB continuously. In training data of a certain quality, a higher complexity of model M, MA, MB then generally also results in a further improvement of the recognition performance.

The error rate may be used for example as the criterion for determining a suitable complexity of model M, MA, MB in a specific step of the iterative method. In particular, a comparison of the error rate of the predicted labels L with the error rate of a specific training sample may be advantageous. If the error rate of the predicted labels L is worse, it may be advantageous to adapt the complexity of model M, MA, MB.

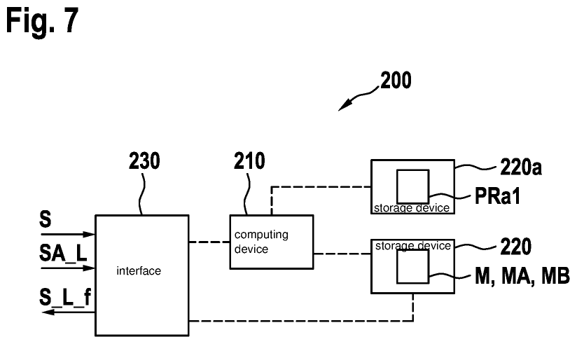

FIG. 7 finally shows a device 200, device 200 being designed to carry out a method 100 and/or a method 1000 in accordance with the described specific embodiments.

Device 200 comprises a computing device 210 and a storage device 220, in particular for storing a model, in particular a neural network. Device 210 in the example comprises an interface 230 for an input and an output of data, in particular for an input of the data of data set S and/or of labels L and/or of the labeled first subset SA_L_1 and for an output of labels L and/or of the final labeled data set S_L_f. Computing device 210 and storage device 220 and interface 230 are connected via at least one data line 240. Computing device 210 and storage device 220 may be integrated in a microcontroller. Device 200 may also be designed as a distributed system in a server infrastructure.

The specific embodiments provide for the computing device 210 to be able to access a storage device 220a, on which a computer program PRG1 is stored, the computer program PRG1 comprising computer-readable instructions, in the execution of which by a computer, in particular by computing device 210, the method 100 and/or the method 1000 is carried out in accordance with the specific embodiments.

An exemplary use of the method 100, 1000 is explained below with reference to the example of a use in a system for biometric voice recognition. The use in further biometric recognition methods, in particular facial recognition, iris recognition etc. is likewise possible.

Initially, a small amount of voice material is provided in the form of a data set S, of a user who is initially still unknown. From this set, the system is able to learn the user in a first learning process, the so-called “enrollment”. For example, the labeling of subset SA_L, or depending on the specific embodiment SA_L_1 or SC_L, may be performed by the user himself. By applying the method 100, 1000, in the further course the labeled subsets SA_L_n, SB_L_n, or SB_n_L, and, if indicated, finally the labeled data set S_L or S_L_f are then generated.

Example of application: Environmental perception of autonomous or partially autonomous vehicles

A further specific example of an application of method 100, 1000 is the environmental perception for autonomous or partially autonomous driving. For this purpose, a vehicle is equipped with at least one sensor, which detects static, i.e., stationary, and dynamic, i.e., movable objects in the surroundings of the vehicle. Advantageously, the vehicle may be equipped with multiple sensors, in particular with sensors of different modalities, for example with a combination of cameras, radar sensors, lidar sensors and/or ultrasonic sensors. This is then a multi-modal sensor set. The vehicle thus equipped is used in order to record the at first unlabeled sample of sensor data and to store these as data set D. The objective of the environmental perception is to recognize the static and dynamic objects in the surroundings of the vehicle and to localize these and thus to generate a symbolic representation of these objects including the time characteristic. This symbolic representation is typically provided by partially time-dependent attributes of these objects, for example attributes for the object type such as passenger car, cargo truck, pedestrian, bicycle rider, guardrail, object that can be driven over or cannot be driven over, lane marking and other attributes such as for example the number of axles, size, shape, position, orientation, speed, acceleration, state of the driving direction indicator and so on.

The trained models MA, MB for recognizing the objects and for determining relevant attributes may a combination of at least one submodel for one of the sensor modalities and a further fusion submodel. The fusion submodel may comprise a deep neural network architecture for performing a fusion of data over time and/or for performing a fusion of data of the various sensors and/or modalities. In particular, models MA, MB may represent an architecture, which contains one or multiple single-frame subnetworks, each of these single-frame subnetworks performing a single-frame recognition. The fusion subnetwork, which may be contained in the overall architecture, is able to fuse the output of the single-frame subnetworks and achieve the fusion over time and/or the multimodal fusion. In particular, it is possible to use a “recurrent neural network” (RNN) for the architecture of the fusion subnetwork for fusion over time. The “long short term memory” (LSTM) architecture may be also be used in this case in order to be better able to include information over longer time periods in the recognition. The fusion over time and/or the fusion of the various sensors and/or the fusion of the various sensor modalities may be implemented in a deep neural network as “early fusion”, the input variables into the neural network being suitably combined in this case, for example as multiple channels (similar to the concept of RGB images). Furthermore, the fusion may be implemented as “late fusion”, the outputs of several mutually independent neural networks being suitably combined in this case, for example by averaging. The fusion may also be achieved by intermediate forms of these two types, that is, by “middle fusion”, where generally more complex features of multiple subnetworks are suitably combined, for example as multiple channels or by addition. Alternatively, the fusion over time and/or the fusion of the various sensors and/or of the various sensor modalities may also be achieved using a non-trained approach, in particular using a Kalman filter.

A single-frame subnetwork for recognizing an individual camera frame, that is, a single image of a camera, may be for example a convolutional deep neural network. The single-frame subnetwork for recognizing a point cloud, for example of an individual sensor sweep of a lidar sensor or of a scan of a radar sensor, may be for example likewise a convolutional deep neural network, which receives as input data either a 2D projection of the point cloud, or, in the case of a 3D CNN, 3D convolutions are performed, the point cloud then being represented in a regular 3D grid. Alternatively, it may be a deep neural network having a PointNet or PointNet++ architecture, it being possible in this case to process the point cloud directly.

Model MA may be trained in step 141n on the basis of labels L_A_n. The model MB may be trained in step 143n on the basis of labels L_B_n. For this purpose, depending on the respective modality, it is possible to perform a transformation of attributes if a training of subnetworks occurs independently of or in addition to the training of the fusion network. For example, in images of a camera, 3D positions of tracked objects may be projected into the camera image, that is into 2D bounding boxes for example.

As an alternative to the use of a trained method for fusion over time, it is possible to track the objects detected in individual frames for example with the aid of a Kalman filter or an extended Kalman filter over time. In this case, at least one single-frame submodel may be contained in the complete models MA, MB. This single frame submodel may be used to predict relevant attributes of the objects. On the basis of these predicted attributes, it is possible to perform an association of the recognized objects on the basis of a comparison with the predicted attributes of the objects already known in the previous time step, it being possible for the prediction of the already known objects to occur for the respective time of measurement. This prediction may occur on the basis of a physical movement model. The attributes predicted by the single-frame submodels may be used for updating the attributes of the associated objects predicted for the time of measurement. The result of the update represents the predictions 142n, 144n of the complete models MA, MB, which in this example respectively contain the submodel including the Kalman filter or the extended Kalman filter and the trained single-frame models.

If the fusion over time is implemented using a trainable model, in particular using a DNN, then the architecture may be chosen in such a way that for recognizing the environment at a specific point in time the DNN has available both the sensor data prior to this point in time as well as after this point in time. This is thus the offline version of the recognition system. The additional use of items of information that lie in the future with respect to an estimated state makes it possible to improve the accuracy and reliability of the recognition, which represents an advantage of the method implemented in this form.

If the fusion is instead realized using a non-trained further model, it is likewise possible to include a method for offline processing. For example, instead of a Kalman filter, it is possible to use a Kalman smoother such as for example the Rauch-Tung-Striebel filter.

Following the complete execution of the iterative process, in both cases, that is, both when using a trained fusion architecture as well as when using a non-trained method, a perception system is achieved that is trained, at least in part, using labeled data of the last iteration. This system may be used as offline perception in order to label further sensor data that were not used in the iterative process. In this manner it is possible to generate further labeled samples automatically. If the offline tracking or the trained offline architecture for the fusion of this perception system is replaced by an online-capable tracking or an online-capable trainable architecture, then this online-capable perception system may be used in a vehicle for implementing the environmental perception of autonomous driving functions.

For example, the Rauch-Tung-Striebel smoother may be replaced by the Kalman filter without smoother, and the same trained models at the single-frame level may continue to be used. In order to reduce the demands with respect to the required computing capacity, it is also possible to use trained single-frame models having reduced complexity for the online version of the perception system, which may be trained on the basis of the labels generated in the last iteration of the iterative process or of the final labels of the data set S_L_f and/or which may be generated by compression and pruning from the trained model MN or MB_N of the last iteration or of the trained final model M_f.

In the case of the use of a trained fusion architecture, this architecture may be modified in such a way that for recognizing the object states at a point in time it only uses the sensor data respectively lying in the past so that an online-capable system is produced even in this case.

The described application of the iterative process for implementing an offline perception and an online perception for autonomous driving functions may also be transferred analogously to other robots. For example, the iterative process may be applied to the implementation of the environmental perception of a household robot, a patient-care robot, a construction site robot or a garden robot.

Further examples of applications: medical image recognition and biometric person recognition

A further application of the method 100 and/or of the method 1000 and/or of the labels generated using the method 100 or using the method 1000 may be in particular in systems for pattern recognition, in particular object detection, object classification and/or segmentation, in particular in the area of medical image recognition, for example segmentation or classification of medical images and/or in the area of biometric person recognition. The application is elucidated below with reference to two independent examples, on the one hand the classification of medical disorders on the basis of x-ray images, computer tomography images (CT) or magnetic resonance tomography images (MRT) and secondly the localization of faces in images as an element of a biometric system for the verification or identification of persons.

The method may be applied in these examples in that first a sample of images of the respective domain is recorded, which represents the at first unlabeled data set S. Thus one obtains for example a sample of CT images of a specific human organ, and in the second example a sample with recordings of faces. In the sampling of the images of faces, it may be advantageous to use video sequences instead of individual, mutually independent photographs, because the method may then be used with tracking over time, as described in connection of the application example of the environmental perception for autonomous or partially autonomous robots.

The step 120, the generation of initial, faulty labels, may be performed in the two application examples by comparatively simple heuristic methods in order to obtain initial labels of a segmentation and/or classification of the images. A concrete example is the segmentation at the pixel level on the basis of a simple threshold value of the respective brightness and/or color values and/or the rule-based classification on the basis of the distribution of all brightness or color values of the entire and/or segmented image. In the case of face localization, a rule-based segmentation of the image may be performed on the basis of typical skin tones. Alternatively, in the two cases of application, it is possible to perform manual labeling, it being possible to carry this out relatively quickly and cost-effectively due to the low requirements regarding the quality of the initial labels.

Models MA and MB, which are trained in the course of the iterative process and are used for the predictions, may be convolutional deep neural networks. In the application case of classification, it is possible to use one hot encoding of the output layer. For the application of facial recognition, which represents a special case of object detection, it is possible to use for example one of the deep neural network architectures YOLO (“you only look once”), R-CNN (“region proposal CNN”), fast R-CNN, faster R-CNN and/or retinanet for models MA and MB.

Since the generation of the initial labels is based on the color information, the generalization may be improved in that the color information is removed from the images at the beginning of the iterative process, that is, in that at first training and prediction in the iteration steps is performed exclusively on the basis of the gray-tone images. In the further course of the iterative process, in particular if portions of the images initially labeled falsely as “face” no longer result in false-positive predictions of the CNN, the color information may be added again so that the entire information may be used.

In the application case of the localization of faces in images, the method according to FIG. 4 may be combined with tracking over time if video sequences exist in data set S.

1-21. (canceled)

22. A method for generating labels for a data set, the method comprising the following steps:
providing an unlabeled data set including a first subset of unlabeled data and at least one further subset of unlabeled data that is disjunctive with respect to the first subset;
generating a labeled first subset by generating labels for the first subset and providing the labeled first subset as an nth labeled first subset where n=1; and
implementing an iterative process, each nth iteration of the iterative process including the following steps for every n=1, 2, 3, . . . N:
training a first model using the nth labeled first subset as an nth trained first model,
generating an nth labeled further subset by predicting labels for the further subset by using the nth trained model,
training a further model using the nth labeled further subset as an nth trained further model, and
generating an (n+1)th labeled first subset by predicting labels for the first subset by using the nth trained further model.

23. The method as recited in claim 22, wherein, following the Nth iteration of the iterative process, a final model is trained using the Nth labeled first subset and/or the Nth labeled further subset.

24. The method as recited in claim 22, wherein a labeled data set and/or a final labeled data set is generated by predicting labels for the data set using the final model.

25. The method as recited in claim 23, wherein the generation of the labeled first subset occurs by predicting labels using an initial model.

26. The method as recited in claim 25, wherein the initial model is trained in a preceding step using a labeled initial subset, the initial subset being disjunctive with respect to the first subset and the further subset.

27. The method as recited in claim 26, wherein the initial subset is smaller than the first subset and/or smaller than the further subset.

28. The method as recited in claim 22, wherein steps of the iterative process are carried out repeatedly for as long as a quality criterion and/or a termination criterion is not yet fulfilled.

29. The method as recited in claim 25, wherein the first model and/or the further model and/or the initial model and/or the final model includes a deep neural network.

30. The method as recited in claim 23, wherein the method further comprises:
increasing a complexity of the first model and/or of the further model and/or of the final model.

31. A method for generating labels for a data set, the method comprising the following steps:
providing an unlabeled data set including a first subset of unlabeled data and at least one further subset of unlabeled data which is disjunctive with respect to the first subset, the further subset including k sub-subsets where k=1, 2, 3 . . . K;
generating an initial labeled subset by generating labels for the first subset;
training a model using the initial labeled subset as the nth trained model where n=1; and
implementing an iterative process, each nth iteration of the iterative process including the following steps for every n=1, 2, 3, . . . N:
generating an nth labeled sub-subset by predicting labels for the kth sub-subset by using the nth trained model, and
training the model as an (n+1)th trained model using the nth labeled sub-subset and/or the initial labeled subset.

32. The method as recited in claim 31, wherein following the Nth iteration of the iterative process, a labeled final further subset is generated by predicting labels for the further subset and/or for the first subset using the trained model.

33. The method as recited in claim 31, wherein a labeled data set including the initial labeled subset and the labeled further subset is generated.

34. The method as recited in claim 31, wherein: (i) a final model is trained using the labeled data set and/or (ii) using the final model, a labeled data set is generated by predicting labels for the data set.

35. The method as recited in claim 31, wherein steps of the iterative process are carried out repeatedly for as long as a quality criterion and/or a termination criterion is not yet fulfilled.

36. The method as recited in claim 34, wherein the model and/or the final model (M_f) include a deep neural network.

37. The method as recited in claim 34, wherein the method further comprises:
increasing a complexity of the model and/or of the final model.

38. A device configured to generate labels for a data set, the device configured to:
provide an unlabeled data set including a first subset of unlabeled data and at least one further subset of unlabeled data that is disjunctive with respect to the first subset;
generate a labeled first subset by generating labels for the first subset and providing the labeled first subset as an nth labeled first subset where n=1; and
implement an iterative process, each nth iteration of the iterative process including the following steps for every n=1, 2, 3, . . . N:
training a first model using the nth labeled first subset as an nth trained first model,
generating an nth labeled further subset by predicting labels for the further subset by using the nth trained model,
training a further model using the nth labeled further subset as an nth trained further model, and
generating an (n+1)th labeled first subset by predicting labels for the first subset by using the nth trained further model.

39. The device as recited in claim 38, wherein the device comprises:
a computing device; and
a storage device configured to storing a neural network.

40. A device configured to generate labels for a data set, the device configured to:
provide an unlabeled data set including a first subset of unlabeled data and at least one further subset of unlabeled data which is disjunctive with respect to the first subset, the further subset including k sub-subsets where k=1, 2, 3 . . . K;
generate an initial labeled subset by generating labels for the first subset;
train a model using the initial labeled subset as the nth trained model where n=1; and
implement an iterative process, each nth iteration of the iterative process including the following steps for every n=1, 2, 3, . . . N:
generating an nth labeled sub-subset by predicting labels for the kth sub-subset by using the nth trained model, and
training the model as an (n+1)th trained model using the nth labeled sub-subset and/or the initial labeled subset.

41. A non-transitory computer-readable storage medium on which is stored a computer program for generating labels for a data set, the computer program, when executed by a computer, causing the computer to perform the following steps:
providing an unlabeled data set including a first subset of unlabeled data and at least one further subset of unlabeled data that is disjunctive with respect to the first subset;
generating a labeled first subset by generating labels for the first subset and providing the labeled first subset as an nth labeled first subset where n=1; and
implementing an iterative process, each nth iteration of the iterative process including the following steps for every n=1, 2, 3, . . . N:
training a first model using the nth labeled first subset as an nth trained first model,
generating an nth labeled further subset by predicting labels for the further subset by using the nth trained model,
training a further model using the nth labeled further subset as an nth trained further model, and
generating an (n+1)th labeled first subset by predicting labels for the first subset by using the nth trained further model.

42. A non-transitory computer-readable storage medium on which is stored a computer program for generating labels for a data set, the computer program, when executed by a computer, causing the computer to perform the following steps:
providing an unlabeled data set including a first subset of unlabeled data and at least one further subset of unlabeled data which is disjunctive with respect to the first subset, the further subset including k sub-subsets where k=1, 2, 3 . . . K;
generating an initial labeled subset by generating labels for the first subset;
training a model using the initial labeled subset as the nth trained model where n=1; and
implementing an iterative process, each nth iteration of the iterative process including the following steps for every n=1, 2, 3, . . . N:
generating an nth labeled sub-subset by predicting labels for the kth sub-subset by using the nth trained model, and
training the model as an (n+1)th trained model using the nth labeled sub-subset and/or the initial labeled subset.

43. The method as recited in claim 22, wherein the method is used for generating training data for training a neural network.

44. The method as recited in claim 31, wherein the method is used for generating training data for training a neural network.
